(19) United States
(12) Patent Application Publication
(10) Pub. No.: US 2023/0196346 A1
(43) Pub. Date: Jun. 22, 2023

(54) METHOD AND SYSTEM OF PROVIDING FOR OFFLINE TRANSACTIONS IN DIGITAL CURRENCIES

(71) Applicant: MASTERCARD INTERNATIONAL INCORPORATED, Purchase, NY (US)

(72) Inventor: Stephen HIGGINS, Co. Dublin (IE)

(73) Assignee: MASTERCARD INTERNATIONAL INCORPORATED, Purchase, NY (US)

(21) Appl. No.: 17/556,381

(22) Filed: Dec. 20, 2021

(51) Int. Cl. G06Q 20/38; G06Q 20/06

(52) U.S. Cl. CPC G06Q 20/3825; G06Q 20/3829; G06Q 20/3827; G06Q 20/38215; G06Q 20/065

(57) ABSTRACT

A method for processing an offline blockchain transaction includes: generating, by first device, an initiate message; transmitting, by the first device, the initiate message to a second device; receiving, by the first device, a handshake message from the second device including a certificate and a recipient public key; verifying, by the first device, the handshake message including verifying the certificate using a certificate chain; generating, by the first device, a pay message including transfer data, the transfer data including data values for a proposed blockchain transaction; transmitting, by the first device, the generated pay message to the second device; receiving, by the first device, an accept message from the second device including a digital signature of the transfer data; and verifying, by the first device, the digital signature of the transfer data using as least the recipient public key.

### FIELD

The present disclosure relates to providing for offline transactions in digital currencies, specifically using a standardized process to enable offline blockchain transactions in a secure manner.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

However, in a traditional blockchain every transaction must be submitted to a node, verified, and included in a new block that is successfully added to the chain for it to be an effective transfer. To use newly acquired cryptographic currency, the transferee must wait for the transaction to be posted to the blockchain. Not only can this process be time consuming, but it also requires either party to the transaction to have an active connection to a blockchain node. There can be many cases where two parties wish to make a transfer of cryptographic currency while lacking sufficient connectivity to a blockchain node, i.e., they are offline. In existing blockchain systems, such transfers are impossible.

Thus, there is a need for a technological solution to enable transfers of cryptographic currency to be performed offline without sacrificing the security, immutability, and privacy of a blockchain.

### SUMMARY

The present disclosure provides a description of systems and methods for processing a standardized offline blockchain transaction. A sender computing device and a recipient computing device, each with a blockchain wallet, exchange a series of messages to accomplish an offline blockchain transaction. Both devices utilize elliptic curve cryptography or another suitable method to encrypt data that is exchanged via the messages. By using references in the messages and proceeding in a known messaging order, both devices can safely and accurately exchange all information suitable to ensure that an offline blockchain transaction can take place securely and without a possibility of double spend. The sender computing device starts by sending the recipient computing device an initiate message, which the recipient computing device responds to with a handshake message, establishing the necessary data for utilizing elliptic curve cryptography. The sender computing device replies with a pay message that includes transfer data for the desired blockchain transaction(s) that is encrypted. The recipient computing device receives the pay message, decrypts the transfer data, verifies that the transfer data is accurate, and then responds with an accept message. The sender computing device receives the accept message and stores the transfer data in a local data store to ensure that the transaction is accounted for appropriately, and provides an accepted message to the recipient computing device, which can then update its own local data store with the transfer data. The result is a secure and verifiable processing of a blockchain transaction offline that can be correctly added to the blockchain once a connection to a blockchain node is established.

A method for processing a standardized offline blockchain transaction includes: generating, by a processor of a first computing device, an initiate message; transmitting, by a transmitter of the first computing device, the initiate message to a second computing device; receiving, by a receiver of the first computing device, a handshake message from the second computing device, the handshake message including at least a certificate and a recipient public key; verifying, by the processor of the first computing device, the handshake message, wherein verifying the handshake message includes at least verifying the certificate using a certificate chain; generating, by the processor of the first computing device, a pay message, the pay message including transfer data, the transfer data including one or more data values for a proposed blockchain transaction; transmitting, by the transmitter of the first computing device, the generated pay message to the second computing device; receiving, by the receiver of the first computing device, an accept message from the second computing device, the accept message including a digital signature of the transfer data, and verifying, by the processor of the first computing device, the digital signature of the transfer data using as least the recipient public key.

A system for processing a standardized offline blockchain transaction includes: a first computing device including at least a receiver, a processor, and a transmitter; and a second computing device, wherein the processor of the first computing device generates an initiate message, the transmitter of the first computing device transmits the initiate message to the second computing device, the receiver of the first computing device receives a handshake message from the second computing device, the handshake message including at least a certificate and a recipient public key, the processor of the first computing device verifies the handshake message, wherein verifying the handshake message includes at least verifying the certificate using a certificate chain, and generates a pay message, the pay message including transfer data, the transfer data including one or more data values for a proposed blockchain transaction, the transmitter of the first computing device transmits the generated pay message to the second computing device, the receiver of the first computing device receives an accept message from the second computing device, the accept message including at least a digital signature of the transfer data, and the processor of the first computing device verifies the digital signature of the transfer data using at least the recipient public key.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for processing a standardized offline blockchain transaction in accordance with exemplary embodiments.

FIG. 2 is a block diagram illustrating computing devices for processing a standardized offline blockchain transaction in the system of FIG. 1 in accordance with exemplary embodiments.

FIGS. 3A-3C are a flow diagram illustrating a process for processing a standardized offline blockchain transaction in the system of FIG. 1 in accordance with exemplary embodiments.

FIG. 4 is a flow chart illustrating an exemplary method for processing a standardized offline blockchain transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Processing Standardized Offline Blockchain Transactions

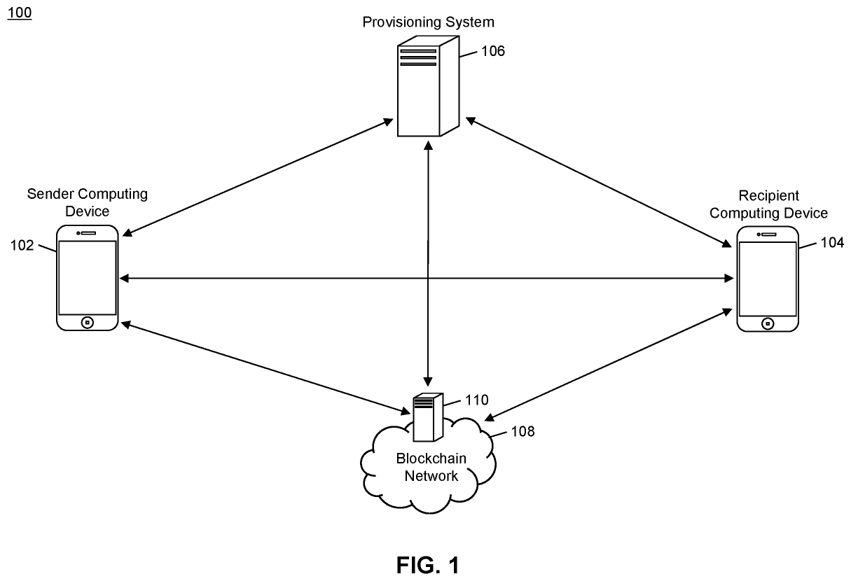

FIG. 1 illustrates a system 100 that utilizes encrypted, standardized messaging to enable successful and secure processing of an offline blockchain transaction.

The system 100 facilitates an offline blockchain transaction conducted between two computing devices, a sender computing device 102 and recipient computing device 104. Each computing can be any type of device suitable for performing the functions discussed herein, such as a desktop computer, laptop computer, tablet computer, notebook computer, cellular phone, smart phone, smart watch, smart television, wearable computing device, etc.

Prior to participating in an offline blockchain transaction, the sender computing device 102 and recipient computing device 104 can be provisioned a certificate by a provisioning system 106. The provisioning system 106 can be an authorized entity that is configured to provision certificates to devices that are authorized to participate in offline blockchain transactions. The provisioning system 106 can verify the authorization of a computing device and provision a certificate thereto, where the certificate or data associated therewith is stored in a certificate chain. The provisioning system 106 can transmit the certificate chain to each computing device or otherwise make the certificate chain available for use by each computing device. A computing device can use the certificate chain to verify the authenticity of a provided certificate to verify that another computing device is authorized to participate in an offline blockchain transaction. Additional data regarding the use of certificates and verification thereof can be found in U.S. patent application Ser. No. 16/509,765, entitled “Method and System for Secure and Verifiable Offline Blockchain Transactions,” by Stephen Higgins, filed on Jul. 12, 2019, which is herein incorporated by reference in its entirety.

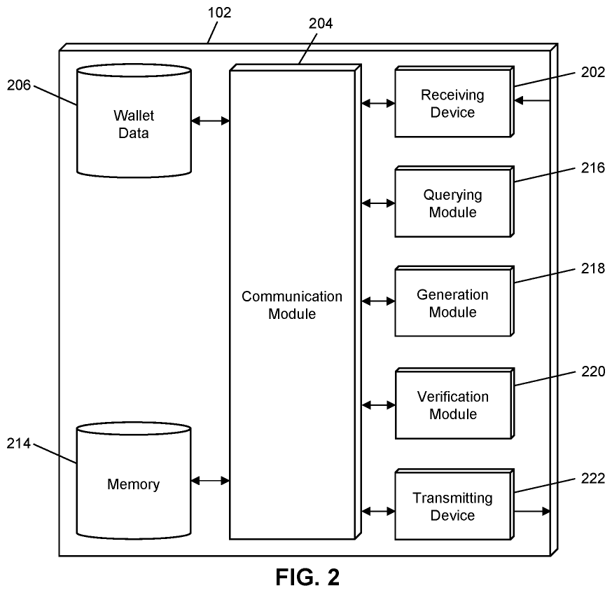

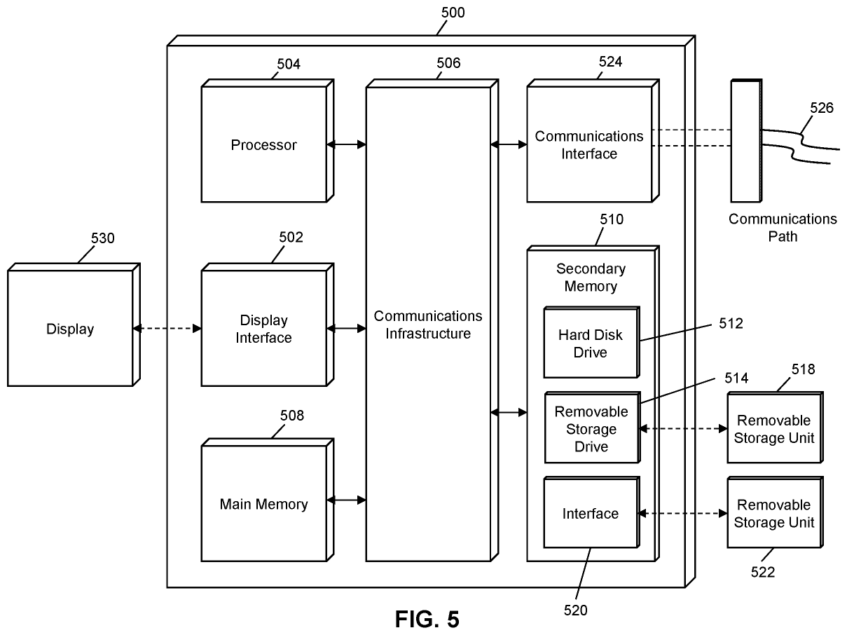

In the system 100, the sender computing device 102 can be interested in sending digital currency to the recipient computing device 104 through an offline blockchain transaction, which is to be recorded in a blockchain. The blockchain can be associated with a blockchain network 108. The blockchain network 108 can be comprised of a plurality of blockchain nodes 110. Each blockchain node 110 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the provisioning system 106 can be a blockchain node 110.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 110 in the blockchain network 108 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 108 using the public key of the cryptographic key pair. In some cases, the term “blockchain wallet” can refer specifically to the private key. In other cases, the term “blockchain wallet” can refer to a computing device (e.g., sender computing device 102, recipient computing device 104, etc.) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., sender computing device 102) that is generated using the sender's private key, a blockchain address of the recipient of currency (e.g., recipient computing device 104) generated using the recipient's public key, and a blockchain currency amount that is transferred, or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 110 in the blockchain network 108, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other nodes in the blockchain network 108 before being added to the blockchain and distributed to all of the blockchain nodes 110 in the blockchain network 108, respectively, in traditional blockchain implementations. In cases where a blockchain data value cannot be related to a blockchain transaction, but instead the storage of other types of data, blockchain data values can still include or otherwise involve the validation of a digital signature.

In the system 100, the sender computing device 102 and recipient computing device 104 can each establish a communication channel with the provisioning system 106 and request a certificate and certificate chain therefrom using a suitable method, such as via a webpage, application program, application programming interface, etc. The provisioning system 106 can generate a certificate for each device and transmit the certificate and certificate chain thereto. In some cases, the provisioning system 106 can first verify a device's authorization and capability for offline blockchain transactions prior to provisioning a certificate thereto. For example, the provisioning system 106 can request the sender computing device 102 to digitally sign (e.g., with its sender private key of the blockchain wallet, referred to herein as a “sender wallet private key”) its local data store regarding the blockchain wallet's available digital currency and transmit the signed data to the provisioning system 106. The provisioning system 106 can verify the digital signature using the sender wallet public key and verify that the data store is correct, such as by validating any digital signatures, blockchain addresses, digital currency amounts, etc. included therein. In another example, the provisioning system 106 can request an attestation from the sender computing device 102, such as to ensure the sender computing device 102 is legitimate and using authentic hardware. Upon successful verification, the provisioning system 106 can generate a certificate for the sender computing device 102, add appropriate data to the certificate chain, and provision the certificate and updated certificate chain to the sender computing device.

Once the sender computing device 102 and recipient computing device 104 both have received certificates and are ready for an offline blockchain transaction, the sender computing device 102 can generate an initiate message. The initiate message can be a message that indicates the sender computing device 102 is ready and interested in an offline blockchain transaction for the transfer of digital currency from the sender computing device's blockchain wallet to the recipient computing device's blockchain wallet. In some embodiments, the initiate message can include a credential associated with the sender computing device 102 or its blockchain wallet for verification by the recipient computing device 104. For example, the initiate message can include the provisioned certificate from the provisioning system 106.

The sender computing device 102 can electronically transmit the initiate message to the recipient computing device 104 using a suitable communication network and method. The recipient computing device 104 can receive the initiate message and determine if it is interested in moving forward with an offline blockchain transaction with the sender computing device 102, such as based on a user instruction. In cases where the initiate message includes a credential, the recipient computing device 104 can first verify the credential before proceeding, such as by checking the supplied provisioned certificate against the certificate chain provided by the provisioning system 106. If the recipient computing device 104 wants to move forward with the transaction, the recipient computing device 104 can generate a handshake message.

The handshake message can include the recipient computing device's certificate provisioned by the provisioning system 106 and a recipient shared public key. The recipient shared public key can be a public key of a cryptographic key pair generated by the recipient computing device 104 for use in establishing a shared secret with the sender computing device 102 for use in encrypting and decrypting data exchanged between the two computing devices, such as using elliptic curve cryptography. As discussed herein, keys used for a shared secret are referred to as “shared” public keys and private keys. As part of the generation of the handshake message, the recipient computing device 104 can digitally sign the certificate and recipient shared public key. The digital signature can be generated using the recipient wallet private key or a private key that corresponds to the provisioned certificate, if different. In latter cases, the corresponding public key can be included in the certificate itself.

The recipient computing device 104 can electronically transmit the handshake message to the sender computing device 102 using a suitable communication network and method. The sender computing device 102 can receive the handshake message and then verify the data included in the message. The sender computing device 102 can verify the digital signature using the appropriate public key, such as the recipient wallet public key (e.g., transmitted with the handshake message, in the handshake message, or in a separate transmission) or the public key included in the certificate. The sender computing device 102 can also verify the provisioned certificate itself using the certificate chain received from the provisioning system 106. If either verification fails, the sender computing device 102 can deny participation in the transaction, such as to avoid potential fraud that can be perpetrated by an unauthorized computing device. If both verifications are successful, the sender computing device 102 can proceed with generating a pay message for the offline blockchain transaction.

To include in the pay message, the sender computing device 102 can generate transfer data. Transfer data can include one or more messages that correspond to one or more blockchain transactions to affect the transfer of digital currency as desired by the sender computing device 102. Each message can include, for example, a destination blockchain address (e.g., generated via the recipient wallet public key), a digital signature (e.g., generated via the sender wallet private key), one or more unspent transaction outputs, and an amount of digital currency. The sender computing device 102 can then encrypt the transfer data before including the transfer data in the pay message. To encrypt the transfer data, the sender computing device 102 can generate a symmetric key. The sender computing device 102 can generate a cryptographic key pair for use in elliptic curve cryptographic or other suitable method, where the cryptographic key pair includes a sender shared private key and a sender shared public key. The sender shared public key can be included in the pay message. The sender computing device 102 can use its sender shared private key and the recipient shared public key to generate the symmetric key, such as using elliptic curve cryptography. The symmetric key can be used by the sender computing device 102 to encrypt the transfer data prior to its inclusion in the pay message.

In addition to the encrypted transfer data and sender shared public key, the pay message can also include a reference value, which can be used by the recipient computing device 104 to ensure that the pay message is part of the expected transaction. The reference value can be any suitable value. In one embodiment, the sender computing device 102 can generate the reference value via hashing the recipient shared public key using a suitable hashing algorithm. The sender computing device 102 can also digitally sign some (e.g., encrypted transfer data and sender shared public key) or all of the data in the pay message using the sender shared private key. The sender computing device 102 can electronically transmit the pay message to the recipient computing device 104 using a suitable communication network and method.

The recipient computing device 104 can receive the pay message and then verify the data included therein. The recipient computing device 104 can verify the reference value by hashing its own recipient shared public key and matching the generated value with the reference value included in the pay message. The recipient computing device 104 can verify the digital signature over the data in the pay message using the sender shared public key included in the pay message. If either verification fails, the recipient computing device 104 can deny further participation in the offline blockchain transaction. If both verifications are successful, then the recipient computing device 104 can decrypt the transfer data. The recipient computing device 104 can generate its own symmetric key using the recipient shared private key and the supplied sender shared public key, such as using elliptic curve cryptography or other suitable method. The recipient device 104 can use the generated symmetric key to decrypt the transfer data. The recipient computing device 104 can then verify the transfer data, such as by verifying the digital signatures, ensuring the unspent transaction outputs have sufficient digital currency, ensuring the destination blockchain address is correct, and ensuring that the digital currency amount is suitable. If any of the transfer data is incorrect, the recipient computing device 104 can deny further participation, or notify the sender computing device 102 accordingly and invite the sender computing device 102 to generate a new pay message.

If the transfer data is accurate and acceptable, then the recipient computing device 104 can generate an accept message. An accept message can include at least reference value, which can be a hash of the sender shared public key. In some embodiments, the accept message can also include a digital signature, which can be over the sender shared public key also included in the accept message, which can be generated using the recipient shared private key. In some cases, the accept message can also include the decrypted transfer data, which can also be digitally signed using the recipient shared private key. In some instances, the accept message can include a digital signature over the decrypted transfer data without including the decrypted transfer data itself. In some situations, the accept message can include a hash of the decrypted transfer data. The recipient computing device 104 can then electronically transmit the accept message to the sender computing device 102.

The sender computing device 102 can receive the accept message and verify the data included therein. The sender computing device 102 can verify the reference value by hashing its own sender shared public key and matching the generated value with the reference value included in the accept message. The sender computing device 102 can also verify the digital signature, such as by using the recipient shared public key previously received (e.g., in the handshake message). In cases where the accept message includes the decrypted transfer data, the sender computing device 102 can also verify that the transfer data included in the accept message matches the transfer data previously generated. In cases where the accept message includes a hash of the decrypted transfer data, the sender computing device 102 can verify the hash by hashing the transfer data previously generated and matching it to the hash value included in the accept message. If any verification fails, the sender computing device 102 can stop the transaction process. If the verifications are successful, then the sender computing device 102 stores the transfer data in a local data store and applies the transfer data accordingly to data regarding the device's blockchain wallet, such as by updating the status of unspent transaction outputs, amount of available digital currency, etc. After such storage and updates, the sender computing device 102 can consider the digital currency transferred such that no other transfers can be made, to prevent any possible double spend of the associated digital currency.

The sender computing device 102 can then generate an accepted message. The accepted message can include a reference value, which can be a hash of the recipient shared public key. The accepted message can also include the accept message that is digitally signed by the sender computing device 102 using the sender shared private key. The sender computing device 102 can electronically transmit the accepted message to the recipient computing device 104 using a suitable communication network and method.

The recipient computing device 104 can receive the accepted message and verify the data included therein. The recipient computing device 104 can verify the reference value by hashing its own recipient shared public key and matching the generated value with the reference value included in the accepted message. The recipient computing device 104 can also verify the digital signature over the accept message using the sender shared public key. If either verification fails, the recipient computing device 104 can deny further participation in the offline blockchain transaction. If the verifications are successful, the recipient computing device can store the transfer data in a local data store and apply the transfer data accordingly to data regarding the device's blockchain wallet, such as by updating the status of unspent transaction outputs, amount of available digital currency, etc. After such storage and updates, the recipient computing device 102 can consider the received digital currency to be available for future offline blockchain transactions. The offline blockchain transaction between the sender computing device 102 and recipient computing device 104 can then be considered to be completed.

When either device next establishes communication with a blockchain node 110, the transfer data can be electronically transmitted to the blockchain node 110 using a suitable communication network and method. The blockchain node 110 can validate the transfer data and include the transfer data as new blockchain transaction(s) in the blockchain by including the transfer data in one or more new blockchain data values that are included in one or more new blocks that are verified and confirmed by a majority of the blockchain nodes 110 in the blockchain network 108.

In some embodiments, the sender computing device 102 and recipient computing device 104 can discard any received messages that are unexpected. For instance, once the process has started (e.g., the recipient computing device 104 has transmitted a handshake message to the sender computing device 102), each computing device can discard any message that is not expected based on a known ordering of messages, such as discussed above. For example, after the sender computing device 102 transmits a pay message to the recipient computing device 104, the sender computing device 102 can discard any message received from the recipient computing device 104 or other computing device that is not an accept (e.g., or reject, as discussed below) message from the recipient computing device 104. Such discarding of messages can ensure that an offline blockchain transaction happens fully and in the correct ordering to prevent double spend or any inconsistencies between devices. In some cases, a computing device can inform the other device involved in the transaction if a received message was discarded, such as to provide the other device with an opportunity to generate and transmit the appropriate message. In some instances, the sender computing device 102 and recipient computing device 104 can repeatedly transmit a message based on the current step of the transaction and can continue to transmit copies of that message until the next appropriate message is received from the other device. In such instances, the sender computing device 102 and recipient computing device 104 can be prevented from skipping ahead in the transaction process and ensuring the other device receives every necessary message for the transaction. In such instances, when the sender computing device 102 or recipient computing device 104 receives a message, it may perform the necessary actions, as discussed above, when receiving the first copy of the message, and may not perform any actions when subsequent copies of the message are received.

In cases where one of the computing devices involved in the offline blockchain transaction wants to cancel a transaction, the computing device can generate a cancel message, also referred to herein as a reject message. A computing device can be interested in canceling a transaction due to failed verification, a missed message, a message sent out of order, intervention by a user of the computing device, etc. A cancel message can be generated by the computing device that includes a reference value (e.g., generated by hashing the shared public key of the other computing device) and a digital signature generated over the symmetric key, where the digital signature is generated using the device's shared private key. The cancel message can be transmitted to the other device, which can verify both the reference value and digital signature. The device can also verify the symmetric key by checking that it matches its own symmetric key. Once all values are verified, the device can clear its current transaction. In some instances, a cancel message can refer to an instruction input by a user of the device to cancel a transaction, while a reject message can refer to a message transmitted from one device to another for canceling the transaction.

To clear a transaction, the sender computing device 102 or recipient computing device 104, as applicable, can delete all transfer data, shared public keys, shared private keys, symmetric keys, and any other data associated with the canceled transaction. The sender computing device 102 can also clear any queue of messages, such as a queue for all messages received for a transaction. In some cases, a clearing action can be performed by the sender computing device 102 or recipient computing device 104 once a transaction has been completed, such as to ensure the deletion of messages, keys, and other data associated with the completed transaction.

In some embodiments, an initiate message can include a public key generated by the sender computing device 102 for use in generating a reference for the transaction, referred to herein as a transaction public key. The sender computing device 102 and recipient computing device 104 can use the transaction public key to generate or derive a reference value, such as a session identifier or transaction number, which can be included in one or more of the messages transmitted between the sender computing device 102 and recipient computing device 104, such as to ensure the message is coming from the expected computing device.

The methods and systems discussed herein provide for offline blockchain transactions between two computing devices. By using standardized messages that are transmitted and received in a known order, double spending of digital currency can be prevented. In addition, using shared secrets, hashed reference values, and other techniques discussed herein enable an offline blockchain transaction to be conducted safely and securely even in cases where communications can be intercepted and viewed by other devices. As a result, the methods and systems discussed herein provide for greater versatility in offline blockchain transactions than existing systems due to the technological improvements utilized.

### Computing Device

FIG. 2 illustrates an embodiment of a sender computing device 102. It will be apparent to persons having skill in the relevant art that the embodiment of the sender computing device 102 illustrated in FIG. 2 is provided as illustration only and cannot be exhaustive to all possible configurations of the sender computing device 102 suitable for performing the functions as discussed herein. For example, the computer system 500 illustrated in FIG. 5 and discussed in more detail below can be a suitable configuration of the sender computing device 102. The sender computing device 102 can also be utilized as a recipient computing device 104 in offline blockchain transactions. Similarly, the recipient computing device 104 in the system 100 can also be utilized as a sender computing device 102 in offline blockchain transactions.

The sender computing device 102 can include a receiving device 202. The receiving device 202 can be configured to receive data over one or more networks via one or more network protocols. In some instances, the receiving device 202 can be configured to receive data from other sender computing devices 102, recipient computing devices 104, provisioning systems 106, blockchain nodes 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by other sender computing devices 102 or recipient computing devices 104 that can be superimposed or otherwise encoded with initiate messages, handshake messages, pay messages, accept messages, accepted messages, cancel messages, reject messages, and clear messages, where such messages can include reference values, public keys, symmetric keys, encrypted data, decrypted data, certificates, other messages, and digital signatures, such as discussed above. The receiving device 202 can also be configured to receive data signals electronically transmitted by provisioning systems 106, which can be superimposed or otherwise encoded with certificates and certificate chains. The receiving device 202 can also be configured to receive data signals electronically transmitted by blockchain nodes 110 that can be superimposed or otherwise encoded with blockchain data values, blocks, notification messages, public keys, etc.

The sender computing device 102 can also include a communication module 204. The communication module 204 can be configured to transmit data between modules, engines, databases, memories, and other components of the sender computing device 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the sender computing device 102 and external components of the sender computing device 102, such as externally connected databases, display devices, input devices, etc. The sender computing device 102 can also include a processing device. The processing device can be configured to perform the functions of the sender computing device 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The sender computing device 102 can include wallet data 206. The wallet data 206 can be configured to store data associated with a blockchain wallet and offline blockchain transactions using a suitable data storage format and schema. The wallet data 206 can be stored in a relational database that utilizes structured query language for the storage, identification, modifying, updating, accessing, etc. of structured data sets stored therein. Wallet data 206 can include, for example, cryptographic key pairs, unspent transaction outputs, digital signatures, blockchain addresses, digital currency amounts, provisioned certificates, certificate chains, a message queue of messages, symmetric keys, transfer data, etc.

The sender computing device 102 can also include a memory 214. The memory 214 can be configured to store data for use by the sender computing device 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the sender computing device 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, blockchain data, signature generation algorithms, etc.

The sender computing device 102 can include a querying module 216. The querying module 216 can be configured to execute queries on databases to identify information. The querying module 216 can receive one or more data values or query strings and can execute a query string based thereon on an indicated database, such as the memory 214 of the sender computing device 102 to identify information stored therein. The querying module 216 can then output the identified information to an appropriate engine or module of the sender computing device 102 as necessary. The querying module 216 can, for example, execute a query on the wallet data 206 to identify a shared public key for generating a hash value to check a reference value in a received message.

The sender computing device 102 can also include a generation module 218. The generation module 218 can be configured to generate data for use by the sender computing device 102 in performing the functions discussed herein. The generation module 218 can receive instructions as input, can generate data based on the instructions, and can output the generated data to one or more modules of the sender computing device 102. For example, the generation module 218 can be configured to generate initiate messages, handshake messages, pay messages, accept messages, accepted messages, cancel or reject messages, clear messages, digital signatures, transfer data, reference values, cryptographic key pairs, symmetric keys, etc.

The sender computing device 102 can also include a verification module 220. The verification module 220 can be configured to perform verifications for the sender computing device 102 as part of the functions discussed herein. The verification module 220 can receive instructions as input, which can also include data to be used in performing a verification, can perform a verification as requested, and can output a result of the verification to another module or engine of the sender computing device 102. The verification module 220 can, for example, be configured to verify certificates, digital signatures, reference values, transfer data, message ordering, etc.

The sender computing device 102 can also include a transmitting device 222. The transmitting device 222 can be configured to transmit data over one or more networks via one or more network protocols. In some instances, the transmitting device 222 can be configured to transmit data to other sender computing devices 102, recipient computing devices 104, provisioning systems 106, blockchain nodes 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to other sender computing devices 102 and recipient computing devices 104 that can be superimposed or otherwise encoded with initiate messages, handshake messages, pay messages, accept messages, accepted messages, cancel messages, reject messages, and clear messages, where such messages can include reference values, public keys, symmetric keys, encrypted data, decrypted data, certificates, other messages, and digital signatures, such as discussed above. The transmitting device 222 can also be configured to electronically transmit data signals to provisioning systems 106, which can be superimposed or otherwise encoded with requests for certificates and/or certificate chains. The transmitting device 222 can be further configured to electronically transmit data signals to blockchain nodes 110 that can be superimposed or otherwise encoded with transfer data for new blockchain transactions.

### Process for Offline Blockchain Transactions

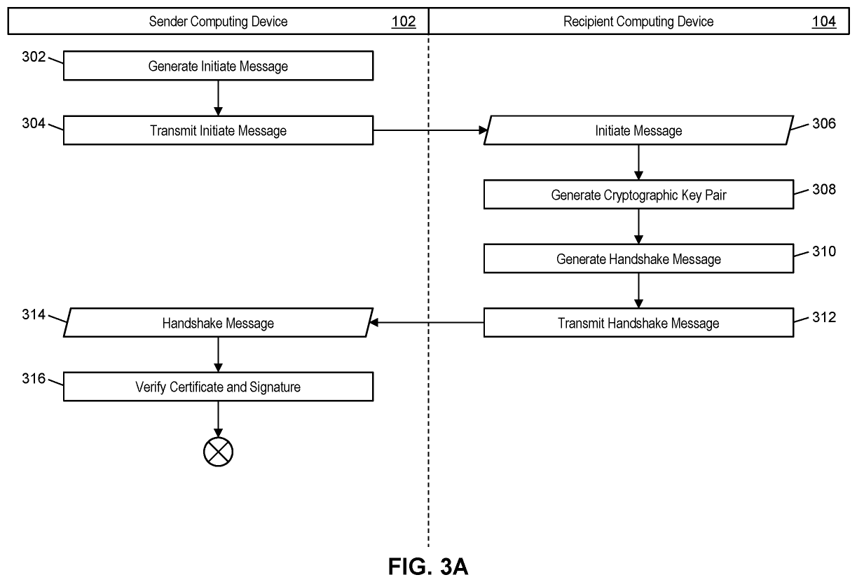

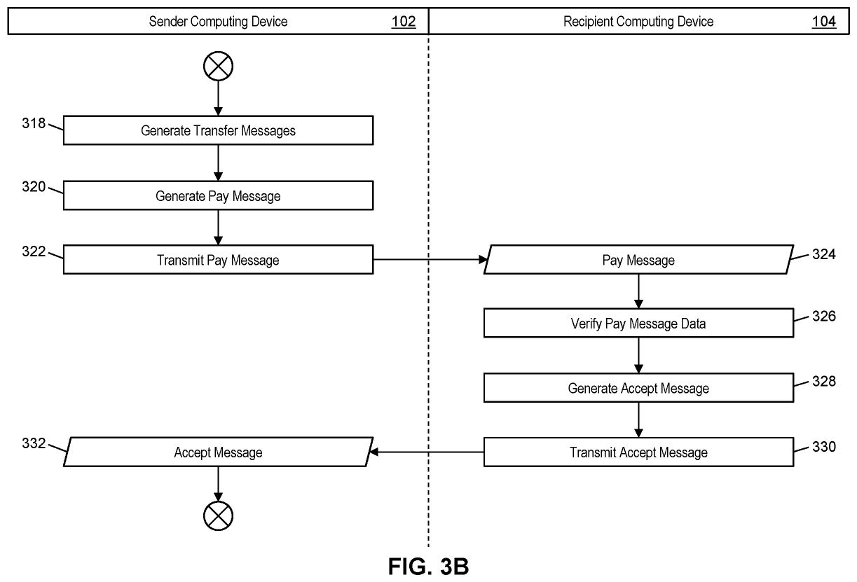

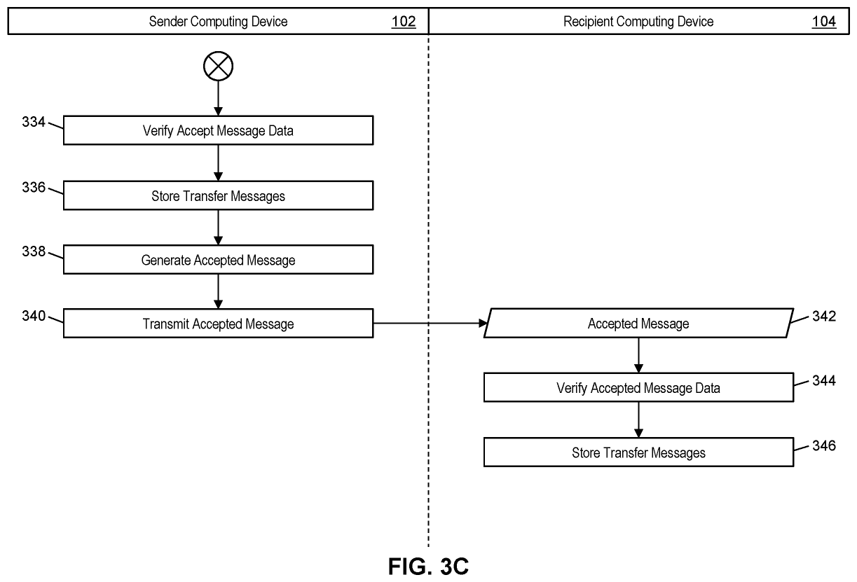

FIGS. 3A-3C illustrate a process for an offline blockchain transaction between the sender computing device 102 and recipient computing device 104 in the system 100 of FIG. 1 using standardized, ordered messaging.

In step 302, the generation module 218 of the sender computing device 102 can generate an initiate message for initiating an offline blockchain transaction with the recipient computing device 104. The initiate message can include information regarding the desired transfer of digital currency, such as an amount of digital currency. In step 304, the transmitting device 222 of the sender computing device 102 can electronically transmit the initiate message to the recipient computing device 104 using a suitable communication network and method. In step 306, a receiving device 202 of the recipient computing device 104 can receive the initiate message.

In step 308, a generation module 218 of the recipient computing device 104 can generate a cryptographic key pair to be used for generating a shared secret for use in the offline blockchain transaction including a recipient shared public key and a recipient shared private key. In step 310, the generation module 218 of the recipient computing device 104 can generate a handshake message. The handshake message can include at least the provisioning certificate of the recipient computing device 104, the recipient shared public key, and a digital signature of the certificate and recipient shared public key, such as using the recipient wallet private key. In step 312, a transmitting device 222 of the recipient computing device 104 can electronically transmit the handshake message to the sender computing device 102 using a suitable communication network and method. In step 314, the receiving device 202 of the sender computing device 102 can receive the handshake message.

In step 316, the verification module 220 of the sender computing device 102 can verify the digital signature over the certificate and recipient shared public key using a suitable public key, such as the recipient wallet public key, and verify the certificate using the certificate chain from the provisioning system 106. In step 318, the generation module 218 of the sender computing device 102 can generate transfer messages for the desired transfers of digital currency, where each transfer message includes suitable information for a blockchain transaction, such as one or more unspent transaction outputs, digital signatures, destination addresses, and digital currency amounts. In step 320, the generation module 218 of the sender computing device 102 can generate a pay message. The pay message can include a reference value (e.g., generated by the generation module 218 via hashing the recipient shared public key), encrypted transfer messages (e.g., encrypted using a symmetric key generated using the recipient shared public key and a sender shared private key generated by the generation module 218), the sender shared public key, and a digital signature over the encrypted transfer messages and sender shared public key generated using the sender shared private key. In step 322, the transmitting device 222 of the sender computing device 102 can electronically transmit the pay message to the recipient computing device 104 using a suitable communication network and method.

In step 324, the receiving device 202 of the recipient computing device 104 can receive the pay message. In step 326, a verification module 220 of the recipient computing device 104 can verify the data included in the pay message including verifying the reference value using a hash value generated by the generation module 218 of the recipient computing device 104 using its recipient shared public key and the digital signature using the sender shared public key. The generation module 218 of the recipient computing device 104 can also generate a symmetric key using the recipient shared private key and sender shared public key and decrypt the encrypted transfer data using the symmetric key. As part of the verifications in step 326, the verification module 220 of the recipient computing device 104 can also verify the decrypted transfer data.

In step 328, the generation module 218 of the recipient computing device 104 can generate an accept message for the offline blockchain transaction. The accept message can include at least a reference value (e.g., generated via the generation module 218 hashing the sender shared public key) and a digital signature over the decrypted transfer messages using the recipient shared private key. In step 330, the transmitting device 222 of the recipient computing device 104 can electronically transmit the accept message to the sender computing device 102 using a suitable communication network and method. In step 332, the receiving device 202 of the sender computing device 102 can receive the accept message.

In step 334, the verification module 220 of the sender computing device 102 can verify the data included in the accept message including verifying the reference value (e.g., matching it to a value generated by the generation module 218 hashing the sender shared public key) and verifying the digital signature over the decrypted transfer messages using the recipient shared public key. In some cases, the verification module 220 can also verify the decrypted transfer data. In step 336, the querying module 216 of the sender computing device 102 can execute a query on the wallet data 206 to store the transfer messages therein and update and data stored regarding the blockchain wallet accordingly, such as updating available digital currency amounts and unspent transaction outputs. In step 338, the generation module 218 of the sender computing device 102 can generate an accepted message. The accepted message can include a reference value (e.g., via the generation module 218 hashing the recipient shared public key), the accept message, and a digital signature over the accept message (e.g., generated by the generation module 218 using the sender shared private key). In step 340, the transmitting device 222 of the sender computing device 102 can electronically transmit the accepted message to the recipient computing device 104 using a suitable communication network and method.

In step 342, the receiving device 202 of the recipient computing device 104 can receive the accepted message. In step 344, the verification module 220 of the recipient computing device 104 can verify the data included in the accepted message, such as by verifying the reference value by matching it against a hash of the recipient shared public key (e.g., generated via the generation module 218 of the recipient computing device 104) and verifying the digital signature over the accept message using the sender shared public key. In step 346, the querying module 216 of the recipient computing device 104 can execute a query on the wallet data 206 to store the transfer messages therein and update and data stored regarding the blockchain wallet accordingly, such as updating available digital currency amounts and unspent transaction outputs.

### Exemplary Method for Processing an Offline Blockchain Transaction

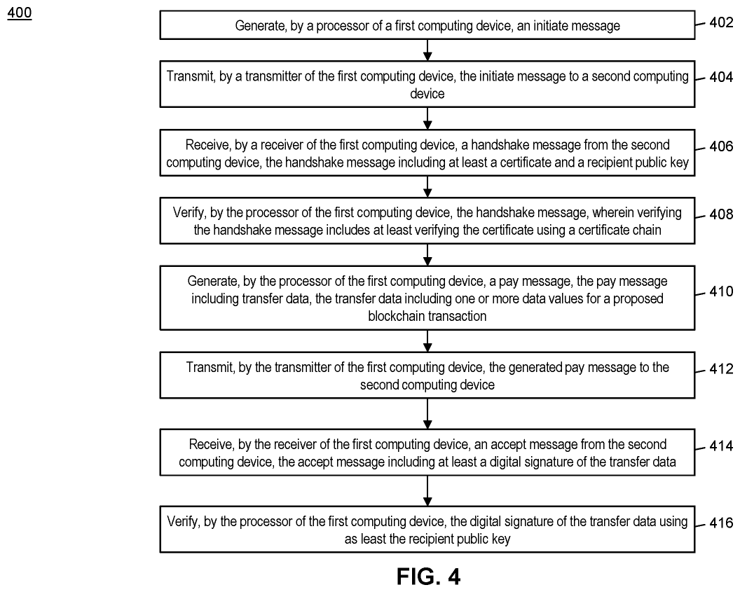

FIG. 4 illustrates a method 400 for processing a standardized offline blockchain transaction using standardized, ordered messaging and cryptography.

In step 402, an initiate message can be generated by a processor (e.g., generation module 218) of a first computing device (e.g., sender computing device 102). In step 404, the initiate message can be transmitted by a transmitter (e.g., transmitting device 222) of the first computing device to a second computing device (e.g., recipient computing device 104). In step 406, a handshake message can be received by a receiver (e.g., receiving device 202) of the first computing device from the second computing device, the handshake message including at least a certificate and recipient public key. In step 408, the handshake message can be verified by the processor (e.g., verification module 220) of the first computing device, wherein verifying the handshake message includes at least verifying the certificate using a certificate chain.

In step 410, a pay message can be generated by the processor (e.g., generation module 218) of the first computing device, the pay message including transfer data, the transfer data including one or more data values for a proposed blockchain transaction. In step 412, the generated pay message can be transmitted by the transmitter of the first computing device to the second computing device. In step 414, an accept message can be received by the receiver of the first computing device from the second computing device, the accept message including at least a digital signature of the transfer data. In step 416, the digital signature of the transfer data can be verified by the processor (e.g., verification module 220) of the first computing device using at least the recipient public key.

In one embodiment, the certificate and recipient public key in the handshake message can be digitally signed and verifying the handshake message can further include verifying the digital signature of the certificate and recipient public key in the handshake message using a certificate public key included in the certificate. In some embodiments, generating the pay message can further include: generating, by the processor (e.g., generation module 218) of the first computing device, a symmetric key using the recipient public key and a sender private key; and encrypting, by the processor (e.g., generation module 218) of the first computing device, the transfer data using the symmetric key, and the pay message can further include a sender public key of a cryptographic key pair including the sender private key. In one embodiment, the method 400 can further include: generating, by the processor (e.g., generation module 218) of the first computing device, an accepted message; and transmitting, by the transmitter of the first computing device, the generated accepted message to the second computing device. In a further embodiment, generating the accepted message can further include digitally signing the accept message using a sender private key, and the pay message can further include a sender public key of a cryptographic key pair including the sender private key.

In some embodiments, generating the pay message can further include generating a reference value by hashing the recipient public key, and the pay message can further include the reference value. In one embodiment, the accept message can further include a reference value, and the method 400 can further include: generating, by the processor (e.g., generation module 218) of the first computing device, a hash value by hashing a sender public key; and verifying, by the processor (e.g., verification module 220) of the first computing device, the reference value using the generated hash value. In a further embodiment, the pay message can further include the sender public key.

### Computer System Architecture

FIG. 5 illustrates a computer system 500 in which embodiments of the present disclosure, or portions thereof, can be implemented as computer-readable code. For example, the sender computing device 102, recipient computing device 104, provisioning system 106, and blockchain node 110 of FIG. 1 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A-3C and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A-3C and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for processing a standardized offline blockchain transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for processing a standardized offline blockchain transaction, comprising:
generating, by a processor of a first computing device, an initiate message;
transmitting, by a transmitter of the first computing device, the initiate message to a second computing device;
receiving, by a receiver of the first computing device, a handshake message from the second computing device, the handshake message including at least a certificate and a recipient public key;
verifying, by the processor of the first computing device, the handshake message, wherein verifying the handshake message includes at least verifying the certificate using a certificate chain;
generating, by the processor of the first computing device, a pay message, the pay message including transfer data, the transfer data including one or more data values for a proposed blockchain transaction;
transmitting, by the transmitter of the first computing device, the generated pay message to the second computing device;
receiving, by the receiver of the first computing device, an accept message from the second computing device, the accept message including at least a digital signature of the transfer data; and
verifying, by the processor of the first computing device, the digital signature of the transfer data using as least the recipient public key.

2. The method of claim 1, wherein
the certificate and recipient public key in the handshake message are digitally signed, and
verifying the handshake message further includes verifying the digital signature of the certificate and recipient public key in the handshake message using a certificate public key included in the certificate.

3. The method of claim 1, wherein
generating the pay message further includes:
generating, by the processor of the first computing device, a symmetric key using the recipient public key and a sender private key; and
encrypting, by the processor of the first computing device, the transfer data using the symmetric key, and
the pay message further includes a sender public key of a cryptographic key pair including the sender private key.

4. The method of claim 1, further comprising:
generating, by the processor of the first computing device, an accepted message; and
transmitting, by the transmitter of the first computing device, the generated accepted message to the second computing device.

5. The method of claim 4, wherein
generating the accepted message further includes digitally signing the accept message using a sender private key, and
the pay message further includes a sender public key of a cryptographic key pair including the sender private key.

6. The method of claim 1, wherein
generating the pay message further includes generating a reference value by hashing the recipient public key, and
the pay message further includes the reference value.

7. The method of claim 1, wherein
the accept message further includes a reference value, and
the method further comprises:
generating, by the processor of the first computing device, a hash value by hashing a sender public key; and
verifying, by the processor of the first computing device, the reference value using the generated hash value.

8. The method of claim 7, wherein the pay message further includes the sender public key.

9. A system for processing a standardized offline blockchain transaction, comprising:
a first computing device including at least a receiver, a processor, and a transmitter; and
a second computing device, wherein
the processor of the first computing device generates an initiate message,
the transmitter of the first computing device transmits the initiate message to the second computing device,
the receiver of the first computing device receives a handshake message from the second computing device, the handshake message including at least a certificate and a recipient public key,
the processor of the first computing device
verifies the handshake message, wherein verifying the handshake message includes at least verifying the certificate using a certificate chain, and
generates a pay message, the pay message including transfer data, the transfer data including one or more data values for a proposed blockchain transaction,
the transmitter of the first computing device transmits the generated pay message to the second computing device,
the receiver of the first computing device receives an accept message from the second computing device, the accept message including at least a digital signature of the transfer data, and
the processor of the first computing device verifies the digital signature of the transfer data using as least the recipient public key.

10. The system of claim 9, wherein
the certificate and recipient public key in the handshake message are digitally signed, and
verifying the handshake message further includes verifying the digital signature of the certificate and recipient public key in the handshake message using a certificate public key included in the certificate.

11. The system of claim 9, wherein
generating the pay message further includes:
generating, by the processor of the first computing device, a symmetric key using the recipient public key and a sender private key; and
encrypting, by the processor of the first computing device, the transfer data using the symmetric key, and
the pay message further includes a sender public key of a cryptographic key pair including the sender private key.

12. The system of claim 9, wherein
the processor of the first computing device further generates an accepted message, and
the transmitter of the first computing device further transmits the generated accepted message to the second computing device.

13. The system of claim 12, wherein
generating the accepted message further includes digitally signing the accept message using a sender private key, and
the pay message further includes a sender public key of a cryptographic key pair including the sender private key.

14. The system of claim 9, wherein
generating the pay message further includes generating a reference value by hashing the recipient public key, and
the pay message further includes the reference value.

15. The system of claim 9, wherein
the accept message further includes a reference value, and
the processor of the first computing device further
generates a hash value by hashing a sender public key, and
verifies the reference value using the generated hash value.

16. The system of claim 15, wherein the pay message further includes the sender public key.
